(19) United States
(12) Patent Application Publication
(10) Pub. No.: US 2021/0076763 A1
(43) Pub. Date: Mar. 18, 2021

(54) Cosmetic Article Comprising False Eyelashes

(71) Applicant: Chanel Parfums Beauté, Neuilly-sur-Seine (FR)

(72) Inventors: Nicolas Castex, Colombes (FR); Audrey Ducardonnet, BOIS COLOMBES (FR)

(21) Appl. No.: 16/620,319

(22) PCT Filed: Jun. 6, 2018
(86) PCT No.: PCT/FR2018/051309

§ 371 Date: Dec. 6, 2019

(30) Foreign Application Priority Data
Jun. 6, 2017 (FR) 1755021

(51) Int. Cl. A41G 5/02; B33Y 10/00; B33Y 80/00

(52) U.S. Cl. CPC A41G 5/02; B33Y 80/00; B33Y 10/00

(57) ABSTRACT

The cosmetic article includes a plurality of false eyelashes, a thin support carrying the false eyelashes, and an applicator adhering to the support and having at least one gripping portion for holding the applicator directly by two opposite faces of the gripping portion when the applicator adheres to the support.

### FIELD OF THE INVENTION

The invention relates to cosmetic articles and more precisely false eyelashes.

### BACKGROUND OF THE INVENTION

Cosmetic articles comprising false eyelashes have been known for many years. False eyelashes in fact enhance the eyes by extending the eyelashes or by adding special decorations thereto. Document WO 2014/038808, for example, describes such false eyelashes.

However, since false eyelashes must be fixed directly to a fringe of eyelashes of the user or to the edge of the eyelid, their installation remains difficult, long and tedious. Due to these difficulties, false eyelashes are often reserved for exceptional circumstances and are not used on a daily basis.

False eyelashes in fact generally comprise a thin and narrow adhesive support designed to adhere to the eyelashes or the eyelid and itself carrying the false eyelashes. Since this support must be invisible or virtually invisible on the eye once in position, its dimensions are very small making it difficult to handle especially since it is adhesive or coated with a layer of glue before installation.

### SUMMARY OF THE INVENTION

One objective of the invention is to simplify the use of false eyelashes.

The invention therefore provides for a cosmetic article which comprises:
a plurality of false eyelashes,
a thin support carrying the false eyelashes, a proximal end of the false eyelashes being fixed to the support, and
an applicator adhering to the support and having at least one gripping portion for holding the applicator directly by two opposite faces of the gripping portion when the applicator adheres to the support.

Thus, the gripping portion of the applicator allows the user to guide and install the support on the eye without handling the latter directly. The gripping portion is in fact located entirely or partly away from the support. Before use therefore, the applicator has a gripping portion leaving the opposite faces of the applicator free. Unlike the applicator, it may therefore have a large area. The larger this area, the easier it is to handle the article in order to install the false eyelashes. More precisely, the user simply has to hold the gripping portion alone to install the support directly on the eye. Since the user no longer handles the support directly, the disadvantages due to its very small size are removed. The installation of the false eyelashes on the eye, advantageously on the fringe of eyelashes, is therefore made easier and faster. Advantageously, the invention allows false eyelashes to be used on a daily basis.

The applicator may further have at least any one of the following characteristics:
the applicator projects from the support, along the direction of a width of the support, over a distance greater than or equal to this width, even two times, three times of four times this width,
the applicator projects from the support, along the direction of a length of the support, over a distance greater than or equal to 25% of this length, even 50%, 75%, 100% or 125% of this length, and
the applicator has on each face an area greater than or equal to three times, even 5 times or 10 times an area of the support.

These various embodiments represent various ways of providing the applicator with an extended gripping zone.

Preferably, the applicator comprises at least one lateral extension, such as a lobe, forming the gripping portion.

Thus, the lateral arrangement of the gripping portion makes the support easier to handle and install on the eye. This lateral arrangement in fact leaves the support clearly visible by the user during installation.

The lobe could also extend higher than the support.

In one embodiment, the applicator may comprise two lobes, one on each side of the support. Thus, the user can choose to hold the applicator from the left, from the right, or with two hands holding both lobes together.

Advantageously, the support is curved.

This curve allows the support to follow the natural curve of the eyelid or the row of eyelashes to simplify installation of the false eyelashes and improve the quality of the attachment to the eye.

Advantageously, the support is transparent.

The invisible or virtually invisible nature of the support once installed on the eye is therefore increased.

All the false eyelashes could be left free by the applicator.

Thus, since the applicator does not cover the eyelashes at all, any interference between the applicator and the false eyelashes is avoided when the applicator is unstuck from the support after installing it on the eye.

Preferably, the article comprises a protection element covering the support on a side of the support opposite to the applicator.

This protection element protects the generally adhesive face of the support intended to be placed directly on the eyelid or the eyelashes.

Advantageously, the applicator is more rigid than the protection element. Inversely, in other embodiments, the protection element could be more rigid than the applicator.

In fact, while the protection element is intended to be removed first when using the article, the applicator requires a certain degree of rigidity in order to be handled easily by the user when placing the support on the eye.

Advantageously, an outer face of the protection element is decorated.

The article according to the invention may further have at least any one of the following characteristics:
the area of the applicator on each face is greater than or equal to 150% of the area of the support;
the length of the applicator and/or of the protection element is between 25 and 60 mm, preferably between 30 and 45 mm;
the width of the applicator and/or of the protection element is between 5 and 20 mm, preferably between 10 and 15 mm,
the length of the support is between 10 and 30 mm, preferably between 15 and 25 mm;
the width of the support is between 1 and 10 mm, preferably between 1 and 5 mm;
the thickness of the support is between 10 and 100 microns, preferably less than or equal to 25 microns;
the support comprises polyurethane, and
the protection element comprises paper.

The invention also provides for a method for manufacturing a cosmetic article, wherein the applicator, the support and/or the protection element of the article according to the invention are made by additive synthesis.

Such a manufacturing method, corresponding to a 3D printing manufacturing method, can be used in particular to produce at low cost the article or some parts of the article depending on the dimensional characteristics of the user's eye. The manufacturing method can thus be customised.

The invention also provides for a computer file comprising code instructions that can be used by a computer to control the implementation of the method according to the invention.

The invention further provides for an electronic storage medium comprising stored data to implement the method according to the invention and/or such a file.

The invention also provides for a method of obtaining such a file in order to download it on a telecommunication network.

Lastly, the invention provides for a method of applying false eyelashes on an eye, the method comprising the following steps:
bringing into contact with a user's eye a support carrying false eyelashes and adhering to an applicator, bringing into contact being carried out by holding the applicator directly by two opposite faces of the applicator, and
unsticking the applicator from the support such that the support remains on the eye.

Advantageously, the support is fixed beforehand to the applicator.

### BRIEF DESCRIPTION OF THE DRAWINGS

We will now describe one embodiment of the invention given as a non-limiting example referring to the attached figures, on which:

FIG. 1 is an elevation view and an exploded view of a cosmetic article according to one embodiment of the invention;

FIG. 2 is an elevation view and a cross-sectional view along plane I-I of the article of FIG. 1;

FIG. 3 is a larger-scale view of the detail D of the cross-sectional view of FIG. 2;

FIG. 4 is a view similar to FIG. 2 produced according to another cross-sectional plane;

FIG. 5 is an elevation view and a perspective view showing a first step of the method of using the article;

FIGS. 6 and 7 are views similar to FIG. 5, showing subsequent steps of the method;

FIG. 8 shows the article being gripped during the step of FIG. 7; and

FIGS. 9 and 10 are views similar to those of FIG. 5 showing the last steps of implementing the method.

### DETAILED DESCRIPTION OF THE INVENTION

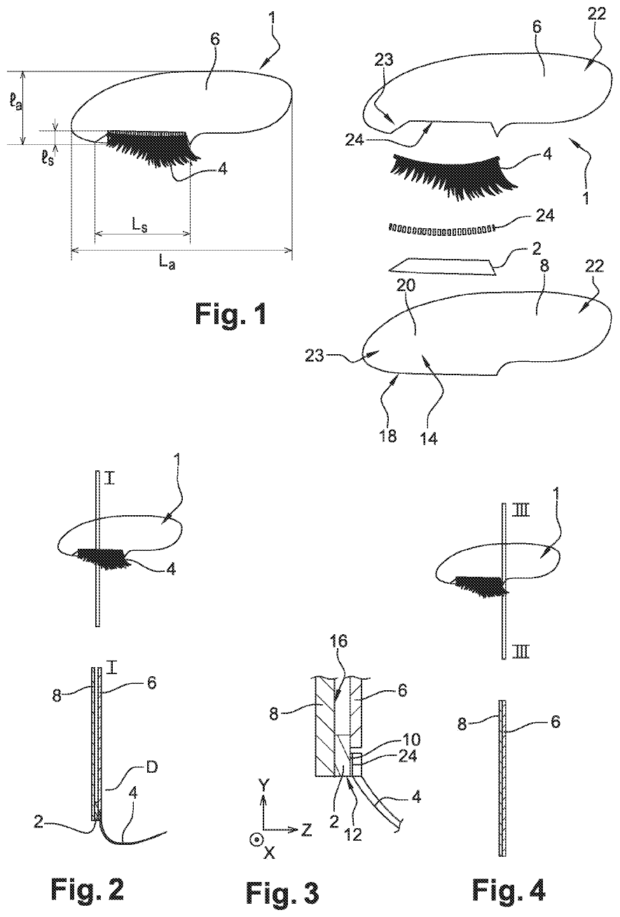

We will first describe the cosmetic article in this embodiment, referring to FIGS. 1 to 4.

The article 1 comprises a support 2, false eyelashes 4, an applicator 6 and a protection element 8.

In this case, the support is flat and thin. In this case, it has the shape of an elongated rectangular strip. As illustrated on FIG. 3, a proximal end of each false eyelash 4 is fixed by gluing to a front face 10 of the support using a strip of glue 24.

The support has for example the shape of a flexible film that is sticky on the side of the support intended to be opposite the protection element. An example of type of film is available under several trade names such as TEGADERM™ (3M Company, St. Paul, Minn.), BIOCLUSIVE™ (Johnson & Johnson Company, New-Brunswick, N.J.), OP-SITE™ (TJ Smith & Nephew, Hull, England) and UNIFLEX™ (Comment Medica, Largo, Fla. It consists for example of a film of transparent polyurethane of thickness between 10 and 100 microns, preferably less than or equal to 25 microns.

As illustrated on FIG. 1, this description uses a coordinate system with three axes X, Y and Z, the X, Y and Z directions designating respectively the length, width and thickness of the support in the article 1.

All the false eyelashes 4 are fixed to the same face of the support. The proximal end of the false eyelashes extends in the median section of this face. Most or even all of the false eyelashes extend projecting from the support, sticking out of its lower face 12. Most of each false eyelash is therefore free. The orientation of the false eyelashes from the support may vary between the eyelashes. For example, the false eyelashes may all be oriented in the same direction along a given inclination or, on the contrary, their inclinations may vary by a few degrees, for example by 10°, 25° or 45° therefore creating a bushy effect. Furthermore, several rows of false eyelashes could extend from the support.

Depending on the final application required, the line of false eyelashes on the user's eyelid could be straight as in the embodiment illustrated by the figures or, on the contrary, curved. Thus, the support 2, from which the false eyelashes extend, and the applicator 6 may be straight or curved in order to guide and install the false eyelashes perfectly on the user's eyelid.

The false eyelashes may be identical to each other or different from each other. For example, the length of each one may be between 5 and 100 mm, for example greater than or equal to 5, 10 or even 15 mm.

The applicator 6 and the protection element 8 both have a generally flat and thin shape. In this case, their contours and dimensions are similar.

The protection element 8 has curved edges over most of its perimeter. It is mostly convex. Its front face 16 comprises a zone 14 for receiving the support 2. In this case, the entire rear face of the support adheres to the front face of the protection element in this zone. To this end, the protection element has a straight lower edge 18 aligned with the lower edge of the support.

Moreover, the protection element extends upwards past the upper edge of the support. It therefore has an upper extension 20, itself extended by a right lobe 22 extending to the right and a smaller left lobe 23, extending to the left, as shown in particular on FIG. 1. The protection element is for example made of paper.

The shape and contour of the applicator 6 are identical to those of the protection element 8 except opposite the receiving zone. The applicator is therefore provided with a recess 24 which extends opposite the support 2 when the protection element 8 and the applicator 6 are superimposed edge to edge as shown on FIGS. 1 to 4. This recess reduces the zone of contact between the rear face of the applicator 6 and the front face 10 of the support such that the latter is only in contact with the applicator on the upper edge of this face. These two parts are therefore easy to separate when applying the false eyelashes. Most of the zone of the front face of the support thus left free is occupied by the ends of the false eyelashes. The applicator may, for example, consist of a silicone-coated sheet of paper, a multilayer sheet of paper, a plastic film or an elastomer film.

In this case, the total length Lₐ of the applicator 6 and of the protection element 8 is 39 mm. Their width lₐ is 13 mm. The total length Lₛ of the support is 20 mm. Its total width lₐ is 2 mm.

More generally:
the length of the applicator and/or of the protection element could be between 25 and 60 mm, preferably between 30 and 45 mm.
the width of the applicator and/or of the protection element could be between 5 and 20 mm, preferably between 10 and 15 mm.
the length of the support could be between 10 and 30 mm, preferably between 15 and 25 mm.
the width of the support could be between 1 and 10 mm, preferably between 1 and 5 mm.

We therefore see that the protection element 8 projects upwards past the support 2, along the direction of the width of the support, over a distance in this case four times greater than this width. In addition, it projects past the support, along the direction of the length of the support, to the left over a distance greater than or equal to 25% of this length and to the right over a distance greater than or equal to 100% of this length. And in this case, the applicator 6 has on each face an area greater than or equal to 5 times or 10 times the area of the support.

In the article, the applicator 6 and the protection element 8 are superimposed edge to edge partly sandwiching the support 2. In addition, in this embodiment, the applicator 6 leaves the false eyelashes 4 completely free without covering them in any way whatsoever. Still in this embodiment, the applicator 6 and the support 2 are two separate or different elements.

The protection element 8 and the applicator 6 are fixed by means of an adhesive to the respective faces of the support 2. The adhesive may be carried by the support or on the contrary be applied to the faces of the protection element 8 and of the applicator intended to be fixed on the support. In the embodiment illustrated on FIG. 1, the adhesive is a strip of glue (not shown) applied to the applicator 6 and to the protection element 8. The protection element 8 is peelable such that it can be easily unstuck from the support 2. The same applies for the applicator 6. On the contrary, the false eyelashes are firmly glued to the face 10 of the support 2 by means of a strip of glue 24 so that they cannot be detached easily from the support. The strip of glue used to fix the various parts of the article, including the false eyelashes, to each other is for example a hypoallergenic acrylate copolymer. The strip of glue 24 is separate from the support 2.

Due to its large dimensions compared with the support 2, the applicator 6 has two gripping portions formed by the left and right lobes 22, 23 and each one allowing the applicator to be held directly by two opposite faces of the gripping portion when the applicator adheres to the support. In particular, the applicator can be held by the left lobe, by the right lobe of by both lobes together.

In this case, the applicator 6 is more rigid than the protection element 8.

We will now present the use of the article which has just been described, in other words the method for applying the false eyelashes on an eye in this embodiment of the invention.

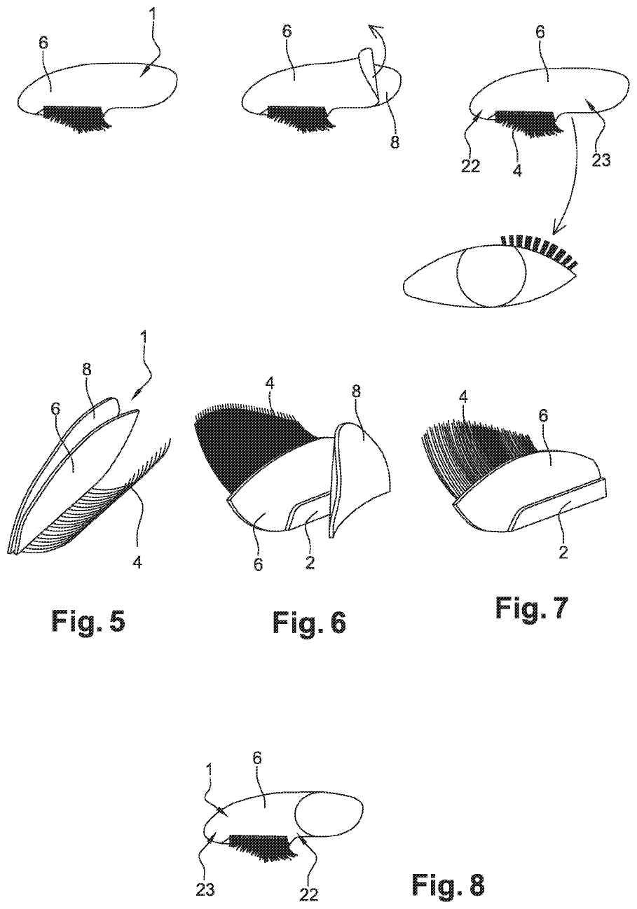

In the first step illustrated on FIG. 5, we assume that the user has the article 1 which has just been described.

Referring to FIG. 6, the user starts by removing the protection element 8 from the article by separating it from the support 2 by peeling. This separation is carried out for example from the right edge of the article as illustrated. As a result, the rear sticky face of the support 2 is now exposed and ready to come into contact with the user's eye.

Referring to FIGS. 7 and 8, the user holds the applicator 6 between her fingers by one of its gripping zones, in this case by its right lobe 22 only. Holding is carried out by applying the fingers on both opposite faces of the applicator 6, directly on them, all the fingers remaining away from the support 2.

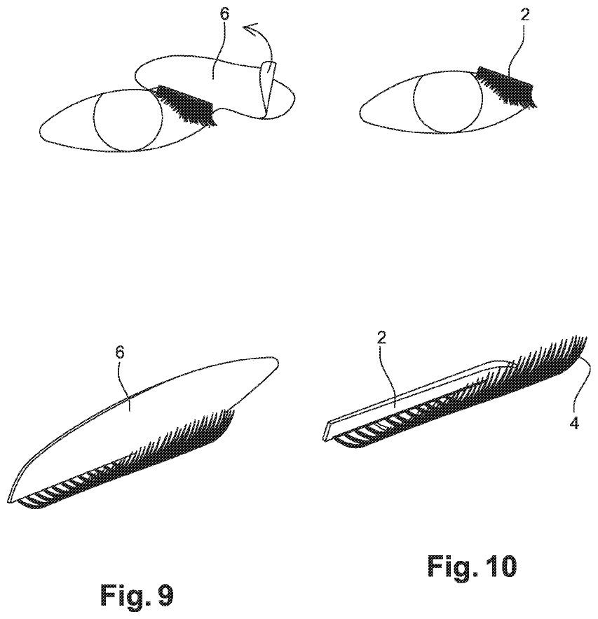

Referring to FIG. 9, the user, while holding the applicator in this way, places the rear face of the support 2 on the base of the eyelashes or on the edge of her eyelid in order to make this face adhere to her eye. Since the gripping zone has a relatively large area, the user can hold the applicator firmly and therefore perform this step by positioning the support precisely on the eye. If the support is not correctly positioned on the eye at the start of the positioning operation, the user can easily reposition it by pulling the applicator and by placing the support on the eye in a new position.

Once the correct position has been obtained, the user applies a slight pressure on the support 2 by pressing on the applicator 6 and/or the distal end of the false eyelashes using her finger or an instrument in order to make the rear face of the support adhere firmly to her eye.

Referring to FIG. 10, the user can then pull the applicator 6, still held by its gripping zone, to separate it from the support. Thus, only the support 2 and the false eyelashes remain on the eye. The installation is now completed.

We therefore see that this method comprises the following steps:
bringing into contact with a user's eyelid the support 2 carrying the false eyelashes 4 and adhering to the applicator 6, bringing into contact being carried out by holding directly the two opposite faces of the applicator, and
unsticking the applicator 6 from the support 4 such that the support 2 remains on the eye.

We see in particular that with this embodiment, there is no need to apply glue to one of the elements before or when using the article.

Like the eyelashes, the false eyelashes can be made up. If necessary, the support can be dimensioned and made up in order to play a role in the required make-up effect.

In the method for manufacturing the article, the applicator 6, the support 2 and/or the protection element 8 can be manufactured by additive synthesis using traditional 3D printing techniques. The method may use a computer file comprising code instructions that can be used by a computer to control the implementation of the method and an electronic storage medium comprising stored data, in particular dimensional, to implement the method and the file. The invention may provide for a method of obtaining the file in order to download it on a telecommunication network.

Obviously, numerous modifications can be made without leaving the scope of the invention.

The support, the protection element and/or the applicator could be curved.

An outer face of the protection element or of the applicator could be decorated, for example by having been printed.

1. A cosmetic article comprising:
a plurality of false eyelashes,
a thin support carrying the false eyelashes, a proximal end of the false eyelashes being fixed to the support, and
an applicator adhering to the thin support and having at least one gripping portion for holding the applicator directly by two opposite faces of the gripping portion when the applicator adheres to the thin support.

2. The article according to claim 1, wherein the applicator projects from the thin support, along the direction of a width of the thin support, over a distance greater than or equal to this width.

3. The article according to claim 1, wherein the applicator projects from the thin support, along the direction of a length Ls of the thin support, over a distance greater than or equal to 25% of this length, even 50%, 75%, 100% or 125% of this length.

4. The article according to claim 1, wherein the applicator has on each face an area greater than or equal to three times, even 5 times or 10 times an area of the thin support.

5. The article according to claim 1, wherein the applicator comprises at least one lateral extension, such as a lobe, forming the gripping portion.

6. The article according to claim 1, wherein the thin support is curved.

7. The article according to claim 1, wherein the thin support is transparent.

8. The article according to claim 1, wherein all the false eyelashes are left free by the applicator.

9. The article according to claim 1, comprising a protection element covering the thin support on a side of the support opposite to the applicator.

10. The article according to claim 9, wherein the applicator is more rigid than the protection element.

11. The article according to claim 9, wherein an outer face of the protection element is decorated.

12. A method for manufacturing a cosmetic article according to claim 1 wherein, one or more of the group consisting of the applicator, the support and a protection element, are made by additive synthesis.

13. A computer file comprising code instructions that can be used by a computer to control the implementation of the method according to claim 12.

14. An electronic storage medium comprising stored data to implement the method according to the claim 12.

15. The method of obtaining a file according to claim 13 in order to download it on a telecommunication network.

16. A method of applying false eyelashes, the method comprising the following steps:
bringing into contact with a user's eyelid or eyelashes a support carrying false eyelashes and adhering to an applicator, bringing into contact being carried out by holding the applicator directly by two opposite faces of the applicator, and
unsticking the applicator from the support such that the support remains on the eyelid or eyelashes.

17. The method according to claim 16, wherein the false eyelashes are fixed beforehand to the support.

18. The article according to claim 1, wherein the applicator projects from the thin support, along the direction of a width of the thin support, over a distance greater than or equal to two times this width.

19. The article according to claim 1, wherein the applicator projects from the thin support, along the direction of a width of the thin support, over a distance greater than or equal to three times this width.

20. The article according to claim 1, wherein the applicator projects from the thin support, along the direction of a width of the thin support, over a distance greater than or equal to four times this width.
